(19) United States
(12) Patent Application Publication
(10) Pub. No.: US 2002/0022704 A1
(43) Pub. Date: Feb. 21, 2002

(54) Process for producing di-or trifunctional initiator systems based on lithium and their use

(76) Inventors: Ellen Giebeler, Koln (DE); Pierre Lutz, Bischheim (FR); Joel Hoffstetter, Baldersheim (FR)

Correspondence Address: BAYER CORPORATION, PATENT DEPARTMENT, 100 BAYER ROAD, PITTSBURGH, PA, 15205, US

(21) Appl. No.: 09/915,089

(22) Filed: Jul. 24, 2001

(30) Foreign Application Priority Data
Jul. 25, 2000 (DE) 10036055.6

(51) Int. Cl. C08F 4/46

(52) U.S. Cl. 526/173

(57) ABSTRACT

The present invention relates to an improved process for producing di- or trifunctional initiator systems based on lithium and their use for the polymerization of conjugated dienes, in particular for the copolymerization of conjugated dienes with aromatic vinyl compounds.

### FIELD OF THE INVENTION

The present invention relates to an improved process for producing di- or trifunctional initiator systems based on lithium and their use for the polymerization of conjugated dienes, in particular for the copolymerization of conjugated dienes with aromatic vinyl compounds.

### BACKGROUND OF THE INVENTION

Difunctional anionic polymerization initiators and their use for the production, in particular, of copolymers based on conjugated dienes and aromatic vinyl compounds have been known for a long time. In this connection, European Patent Applications EP-A 690 075, EP-A 682 041 and EP-A 743 330 are referred to, in which are described the production of industrially useable difunctional anionic polymerization initiators and the use thereof, for the production, in particular, of symmetrical linear block copolymers based on conjugated dienes and vinylaromatic compounds. The functional anionic initiators described there, which, as may be inferred, from the above-mentioned European Patent Applications, have advantages as compared with the difunctional anionic polymerization initiators known hitherto, are produced by reacting a monofunctional organolithium initiator with 1,3-diisopropenylbenzene in the presence of an apolar hydrocarbon as solvent, with a small quantity of conjugated dienes and of an ether being added to the reaction mixture. Optionally, the reaction may be carried out in the presence in addition of a tertiary amine and in the presence of an alkoxylithium compound.

The difunctional anionic polymerization initiator described in the above-mentioned European Patent Publications is intended to be used for the production of linear symmetrical block copolymers having a low vinyl content and a narrow molecular weight distribution (M_{w}/Mₙ). The initiators described there do not appear to be suitable for producing statistical copolymers. Moreover, the method of producing the described polymerization initiators is elaborate, as the initiator has to be reacted with a small quantity of conjugated dienes in an additional step. Furthermore, the separation of the ether used from the polymerization mixture on conclusion of the polymerization is likely to prove difficult, so that the initiator system will remain in the process solvent and hence, their use in a multipurpose polymerization plant, in which the solvent is constantly circulated and various catalyst systems are used, is problematic.

The present invention now comprises an easily produced di- or trifunctional initiator system based on lithium, by means of which it is possible to obtain statistical copolymers which, likewise, have a narrow molecular weight distribution, whose vinyl content can be varied widely and which have a to some extent strictly statistical distribution of the monomers used in the polymer chain.

### SUMMARY OF THE INVENTION

Accordingly, the present invention provides a process for producing a di- or trifunctional initiator system based on lithium, which is characterized in that a monofunctional organolithium initiator is reacted with divinylbenzene, diisopropenylbenzene, trivinylbenzene and/or triisopropenylbenzene in the presence of an inert organic solvent, of an ether and optionally of an alkali-organic compound at temperatures of −20° C. to +80° C., wherein one equivalent of the monofunctional organolithium initiator is used per one vinyl double bond, the ether is used in quantities of 0.1 to 20 mol, based on one mol of monofunctional organolithium initiator, and the alkali-organic compound is used in quantities of 0 to 0.5 mol, based on one mol of monofunctional organolithium initiator.

### BRIEF DESCRIPTION OF THE DRAWINGS

FIG. 1 shows a GPC elution diagram of the reaction product obtained from sec-BuLi and m-DIB in pure hexane.

FIG. 2 shows a GPC elution diagram of the reaction product obtained from sec-BuLi and m-DIB in hexane with addition of DEE.

FIG. 3 shows the mass spectrum of the reaction product obtained from sec-BuLi and m-DIB in hexane with addition of DEE.

FIG. 4 shows the GPC elution diagram of the reaction product from Example 4.

### DETAILED DESCRIPTION OF THE INVENTION

The process according to the present invention is carried out at temperatures preferably of 0° C. to 60° C. The quantity of ether is preferably 0.25 to 5 mol and the quantity of alkali-organic compounds is preferably 0 to 0.4 mol, based on one mol of monofunctional organolithium initiator.

In the process according to the present invention, preferably n-butyllithium, secondary butyllithium or tertiary butyllithium are used as monofunctional organolithium initiators; secondary butyllithium is most preferred.

Suitable vinylbenzenes for the process according to the present invention are 1,3-divinylbenzene, 1,3-diisopropenylbenzene, 1,3,5-trivinylbenzene and 1,3,5-triisopropenylbenzene. Besides the pure compounds, technical mixtures thereof may also be used; for example, the technical mixture of divinylbenzene, which is a mixture inter alia of 1,3-, 1,4- and 1,2-divinylbenzene.

The vinylbenzenes and isopropenylbenzenes may, moreover, be used in a mixture with one another.

Preferably, 1,3-diisopropenylbenzene and 1,3,5-triisopropenyl-benzene are used.

Inert organic solvents used in the process according to the present invention are, in particular, non-polar aliphatic or cycloaliphatic hydrocarbons having 5 to 8 carbon atoms, in particular cyclohexane, cyclopentane, hexane, heptane, most preferably cyclohexane, cyclopentane or hexane. The solvents may be used individually and in a mixture with one another and, of course, also in the form of mixtures of their isomers.

Aromatic ethers and aliphatic or cycloaliphatic ethers can be used as ethers in the process according to the present invention; aliphatic or cycloaliphatic ethers are preferred. Preferably used ethers which may be mentioned are: tetrahydrofuran, diethyl ether, ethylene glycol dimethyl ether, ethylene glycol diethyl ether, ethylene glycol tert.-butyl ethyl ether, 2,2-bis(2-oxoanyl)propane, oligomeric oxolanylalkanes, in particular ethylene glycol diethyl ether and ethylene glycol tert.-butyl ethyl ether. The above-mentioned ethers may be used individually and in a mixture with one another.

For the di- or trifunctional initiator system according to the present invention, it can be advantageous to add alkali-organic compounds to the system in order to achieve a more favorable statistical distribution of the monomers involved in the copolymerization. Suitable alkali-organic compounds are, in particular, the organopotassium compounds, for example, the potassium salts of secondary amines, potassium salts of monohydric or polyhydric alcohols and phenols as well as potassium salts of monobasic or polybasic carboxylic acids, in particular, potassium salts of the alcoholates. The following, in particular, may be mentioned: potassium salts of dimethylamine, of di-n-butylamine, of dibutylamine, of lauric acid, of palmitic acid, of stearic acid, of benzoic acid, of phthalic acid, of methyl alcohol, of ethyl alcohol, of isopropyl alcohol, of propyl alcohol, of tert.-butyl alcohol, of tert.-amyl alcohol, of n-hexyl alcohol, of cyclohexyl alcohol or of phenol. Preferably, the potassium salt of tert.-amyl alcohol is used.

The di- and trifunctional initiator systems based on lithium which are produced according to the present invention can be used for the polymerization of conjugated dienes, in particular, for the polymerization of conjugated dienes with vinylaromatic compounds.

Accordingly, the present invention also provides the use of the di- and trifunctional initiator systems based on lithium which are produced by the process according to the present invention for the polymerization of conjugated dienes, in particular for the copolymerization of conjugated dienes with vinylaromatic compounds.

Conjugated dienes which may be mentioned are: 1,3-butadiene, isoprene, 1,3-pentadiene, 2,3-dimethyl-1,3-butadiene, 1-phenyl-1,3-butadiene, 1,3-hexadiene and 1,3-heptadiene. Preferably 1,3-butadiene and isoprene are used.

Vinylaromatic compounds which may be mentioned are: styrene, p-methylstyrene, α-methylstyrene, 3,5-dimethylstyrene, vinyinaphthalene, p-tert.-butylstyrene, divinylbenzene and diphenylethylene, in particular styrene. The vinylaromatic compounds and the conjugated dienes may both be used individually or in a mixture with one another.

The polymerization of the conjugated dienes using the initiator systems according to the present invention and the copolymerization of the conjugated dienes with the vinylaromatic compounds can be carried out in conventional manner in the presence of an inert organic solvent at temperatures of 40° C. to 160° C., with the initiator system according to the present invention being added in conventional quantities (approximately 0.01 to 10 mmol of the di- or trifunctional initiator system, based on 100 g monomer). The polymers or copolymers produced using the initiator system according to the present invention can, of course, also be modified in conventional manner, for example, at the active chain ends, by reacting the polymers or copolymers produced using the initiators according to the present invention with halogenated tin compounds, such as dichloro-dimethyltin or tin tetrachloride, halogenated silicon compounds, such as silicon tetrachloride, silanes, such as tetraethoxysilane, tetramethoxy-silane, 3-chloropropyltriethoxysilane or 2-(3,4-epoxycyclohexyl)-ethyl-trimethoxysilane, aromatic ketones, isocyanates and oxiranes, lactones or lactams. Such modification reactions are known and are described, for example, in EP-A 153 697, EP-A 180 141, EP-A 773 231, U.S. Pat. No. 5,115,006.

The copolymers based on conjugated dienes and on vinyl aromatic compounds which are produced using the initiator system according to the present invention have a molecular weight distribution (M_{w}/Mₙ)≦1.20 and a relative vinyl content, based on the conjugated diene, of 20 to 80%. The copolymers obtained in particular with the alkali-organic compounds possess in addition a strictly statistical polymer chain.

The polymers based on conjugated dienes or based on conjugated dienes and vinylaromatic compounds which are obtained using the initiator system according to the present invention are eminently suitable for producing rubber mixtures, for example, in a mixture with butadiene rubbers and natural rubber. Such rubber mixtures can be used for the manufacture in particular of tires, preferably treads of tires. In addition to an improved workability, the properties of the tire can also be significantly improved as regards rolling resistance and wet skid resistance through the use of the polymers produced using the initiator system according to the present invention, in particular where there is functionalization at both of the chain ends.

### EXAMPLES

The analysis was carried out by means of ¹H-NMR spectroscopy (200 MHz, Bruker AW200), mass spectroscopy and gel permeation chromatography in THF with detection by laser light scattering. All reactions were carried out with the exclusion of air and of moisture.

### Examples 1-3

### Influence of Polar Additives

The influence of polar additives during the synthesis of difunctional initiator systems is shown in the following Examples. Example 1 deals with the case where polar additives are absent; Examples 2 and 3 deal with the case where they are present.

### Example 1

### Comparison: Without Addition of Ether

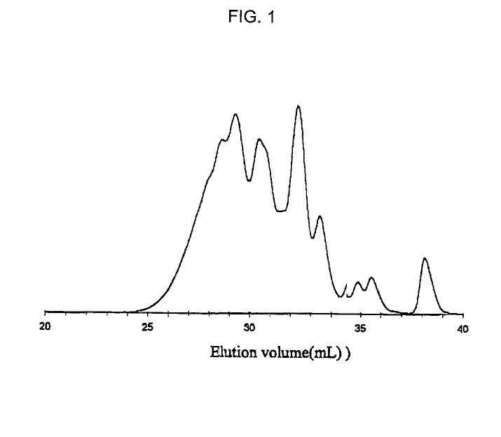

300 ml n-hexane, which had been distilled under argon in the presence of polystyrene anions, was introduced into a 1 liter Büchi glass autoclave equipped with magnetic stirrer and temperature control. 5.83 mmol freshly distilled meta-diisopropenylbenzene (m-DIB) (Aldrich, 98%) was added at 60° C. In order to remove protic impurities, the mixture was titrated with sec-butyllithium (sec-BuLi) until the light yellow coloration characteristic of the DIB anion persisted. Then 11.66 mmol sec-BuLi was added. The reaction time was 1 h 45 min at 60° C. The living species were deactivated by addition of a few drops of oxygen-free methanol. The hexane was removed by vacuum distillation and the product was analyzed using gel permeation chromatography (GPC). FIG. 1 shows that oligomers have formed in addition to the intended difunctional initiator (diadduct).

### Example 2

### With Addition of Ether

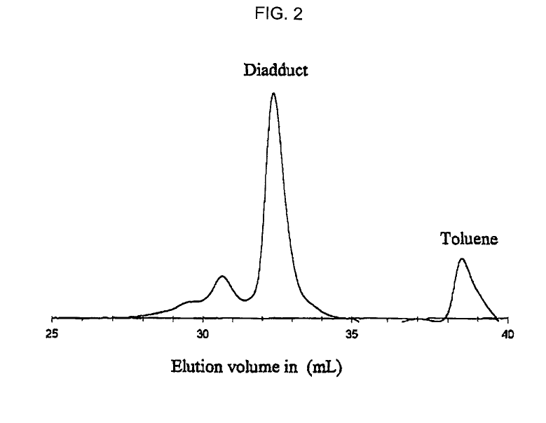

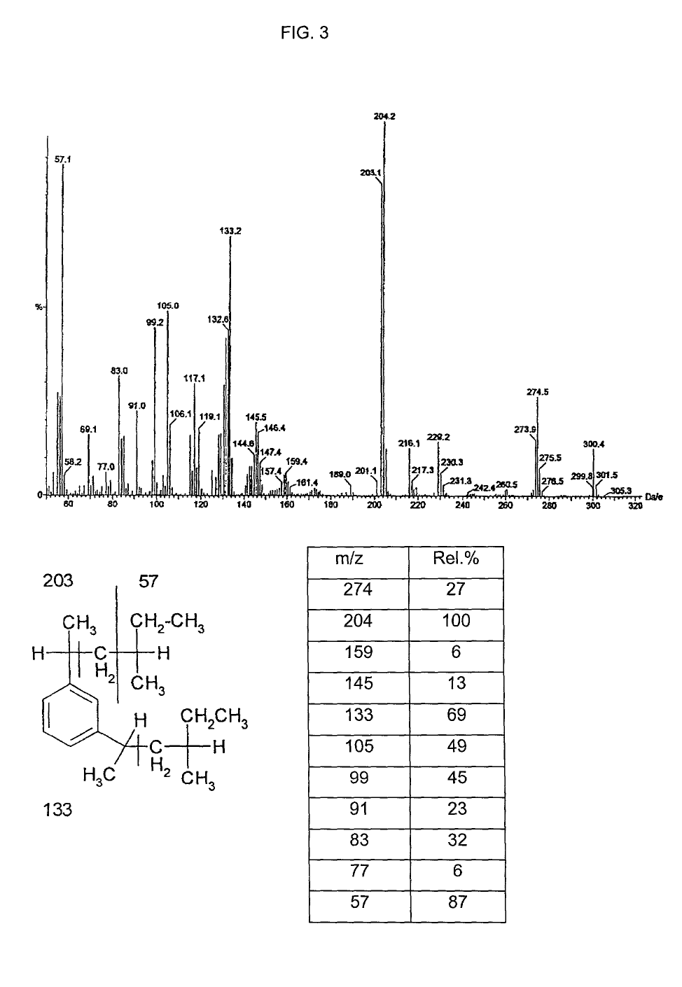

The experimental conditions corresponded to those of Example 1, but in addition 0.58 ml 1,2-diethoxyethane (DEE) (Fluka, 99%) was added. The GPC elution diagram (FIG. 2) shows a main product constituting 75%, which was identified as diadduct by mass spectroscopy (FIG. 3).

### Example 3

### With Addition of Ether and of Alkali-organic Compound

The experimental conditions corresponded to those of Example 1, but in addition 0.7 ml 1-tert-butoxy-2-ethoxyethane (Aldrich, 98%) and 1.1 ml potassium tert-amylate solution (1% in hexane) were added. The result was comparable with that for Example 2.

### Example 4

### Synthesis of Styrene-butadiene Copolymers Using Difunctional Initiator

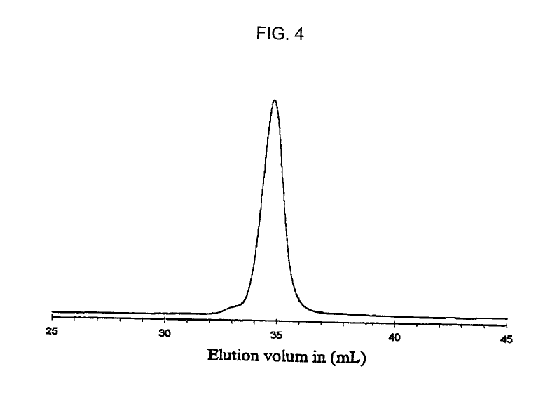

To produce the initiator, 200 ml n-hexane, which had been distilled under argon in the presence of polystyrene anions, 0.12 ml 1-tert-butoxy-2-ethoxyethane (Aldrich) and 1 mmol m-DIB (Aldrich, 98%) were introduced into a 1 liter Büchi glass autoclave equipped with magnetic stirrer and temperature control. The temperature was adjusted to 60° C. In order to remove protic impurities, the mixture was titrated with sec-BuLi until the light yellow coloration characteristic of the DIB anion persisted. Then 2 mmol sec-BuLi was added. The reaction time was 30 minutes at 60° C. The reaction mixture containing the difunctional initiator was cooled to 23° C. and 5 g styrene and 15 g 1,3-butadiene were added. The temperature was again raised to 60° C. After a polymerization time of 2 h 15 min, 4 mmol ethylene oxide was rapidly added. A sharp increase in viscosity and gel formation as a result of the association of the alcoholate groups confirmed the difunctional character of the polymers. The living species were deactivated by addition of a few drops of oxygen-free methanol, with reversal of the gel formation. The polymer was isolated by precipitating the polymer solution in ethanol and stabilized with 2,6-di-tert.-butyl-4-methylphenol. The product was analyzed by gel permeation chromatography (GPC) (FIG. 4). The following values were found: M_{w}=35,400 g/mol and M_{w}/Mₙ=1.14. The species active in polymerization were exclusively difunctional. At 95% conversion, the styrene content was 11 mol. % and the proportion of vinyl units in the polybutadiene was 60%.

The chemical titration of the hydroxyl groups with 1-naphthyl isocyanate confirmed the presence of two functional groups per polymer chain.

### Example 5

### Synthesis of Polybutadiene Using Difunctional Initiator From Example 4

The experimental conditions corresponded to those of Example 4, but 1,3-butadiene was used exclusively as monomer. The polybutadiene obtained was exclusively difunctional and had a vinyl content of 25%. The weight average molecular weight was 38,000 g/mol at a molar mass distribution (M_{w}/Mₙ) of 1.1.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing a di- or trifunctional initiator system based on lithium, comprising the steps of reacting a monofunctional organolithium initiator with divinylbenzene, diisopropenylbenzene, trivinylbenzene and/or triisopropenylbenzene in the presence of an inert organic solvent, of an ether and optionally of an alkali-organic compound at temperatures of −20° C. to +80° C., wherein one equivalent of the monofunctional organolithium initiator is used per one vinyl double bond, where ether is used in quantities of 0.1 to 20 mol, based on one mol of monofunctional organolithium initiator, and the alkali-organic compound is used in quantities of 0 to 0.5 mol, based on one mol of monofunctional organolithium initiator.

2. A process for the polymerization of conjugated dienes comprising di- or trifunctional catalyst system based on lithium, produced by reacting a monofunctional organolithium initiator with divinylbenzene, diisopropenylbenzene, trivinylbenzene and/or triisopropenylbenzene in the presence of an inert organic solvent, of an ether and optionally of an alkali-organic compound at temperatures of −20° C. to +80° C., wherein one equivalent of the monofunctional organolithium initiator is used per one vinyl double bond, where ether is used in quantities of 0.1 to 20 mol, based on one mol of monofunctional organolithium initiator, and the alkaliorganic compound is used in quantities of 0 to 0.5 mol, based on one mol of monofunctional organolithium initiator.

3. A process according to claim 2, wherein said conjugated dienes are copolymerized with vinylaromatic compounds.

4. Polymers comprising conjugated dienes copolymerized with vinyl aromatic compounds comprising a di- or trifunctional initiator system based on lithium

5. A tire product comprising polymers containing conjugated dienes copolymerized with vinyl aromatic compounds comprising a di- or trifunctional initiator system based on lithium produced by reacting a monofunctional organolithium initiator with divinylbenzene, diisopropenyl-benzene, trivinylbenzene and/or triisopropenylbenzene in the presence of an inert organic solvent, of an ether and optionally of an alkali-organic compound at temperatures of −20° C. to +80° C., wherein one equivalent of the monofunctional organolithium initiator is used per one vinyl double bond, where ether is used in quantities of 0.1 to 20 mol, based on one mol of monofunctional organolithium initiator, and the alkali-organic compound is used in quantities of 0 to 0.5 mol, based on one mol of monofunctional organolithium initiator.
